(19) United States
(12) Patent Application Publication
(10) Pub. No.: US 2023/0009263 A1
(43) Pub. Date: Jan. 12, 2023

(54) BOUNDARY LAYER SUCTION DESIGN BY USING A CORE OF A WINGTIP VORTEX FOR A LIFT-GENERATING BODY

(71) Applicant: PAPA ABDOULAYE MBODJ, Orlando, FL (US)

(72) Inventor: PAPA ABDOULAYE MBODJ, Orlando, FL (US)

(21) Appl. No.: 17/683,455

(22) Filed: Mar. 1, 2022

Related U.S. Application Data
(60) Provisional application No. 63/220,509, filed on Jul. 11, 2021.

(51) Int. Cl. B64C 21/06

(52) U.S. Cl. CPC B64C 21/06; B64C 2230/20

(57) ABSTRACT

A boundary layer suction design uses a wingtip vortex core for a lift-generating body with optimized aerodynamic performances. Holes or slots (6), connected to a core or center of a wingtip vortex of the lift generating body via a plenum (9) and pipe (7) with its outlet (8) sticking out from a surface (1) experiencing low pressure, sucked a part of the boundary layer to delay flow transition or separation. Thus, with a more stable boundary layer, the lift is increased while the drag is reduced.

### BACKGROUND OF THE INVENTION

A boundary layer surrounds any body in motion in a fluid. The viscous forces present at the surface of the body are at the origin of the boundary layer. The amount of form and skin friction drags are determined by the behavior of the boundary layer. The skin friction drag increases when there is a transition from a laminar to a turbulent boundary layer. The form drag augments when there is a flow separation with a reverse flow region in the boundary layer. Thus, controlling the boundary layer by sucking a part of it allows a reduction in skin and form drags. Also, an enhancement in the generation of lift is observed.

### BRIEF SUMMARY OF THE INVENTION

The present invention generally provides a design to reduce form, and skin friction drags on any lift-generating body. Also, it enhances the production of lift by controlling the thickness of the boundary layer via suction holes or slots present on the surface of the lift-generating body. The suction force is provided by the low-pressure area present in the core or center of a lift-generating body's wingtip vortex. The holes or slots located on the lift-generating body's surfaces are connected to the low-pressure area present in the wingtip vortex core via a plenum embedded in the lift-generating body and a pipe or channel protruding from the upper surface near the tip. When the lift is produced, the pressure gradient between the lift-generating body's surfaces leads to the formation of a vortex at the tip of the lift-generating body. The vortex is created by the fluid's motion from the high-pressure area on one surface of the lift-generating body called the intrados to the low-pressure area that exists on another surface of the lift-generating body called the extrados. That vortex will create an area of low pressure, which is strongest at its center called the core. Experiments have demonstrated that the core moves onto the upper surface and achieves minimum pressure at a distance from the surface and the trailing edge near the tip.

### STATE OF PRIOR ART

U.S. Pat. No. 6,948,906 B2 disclosed a rotor blade system with reduced blade vortex interaction noise. The rotor blade's tip portion has slots connected through channels to holes placed at the leading edge. Such configuration allows part of the flow to pass from the blade's leading edge through the channels and be expelled out of the rotor blade tip face.

The present invention differs from U.S. Pat. No. 6,948,906 B2 because the tip is closed. No slot or opening is located at the tip. Furthermore, the pressure is not minimal at the tip but in the vortex core situated at a distance from the upper surface near the tip and the trailing edge. Contrary to the present invention, U.S. Pat. No. 6,948,906 B2 does not use the wingtip vortex core low-pressure area. EP 2 631 175 A2 disclosed an adaptive rotor blade system with multiple rotor blades composed of flaps, air outlets, or jet tip outlets. An outlet may be placed at a blade tip of the one or more rotor blades.

The present invention differs from EP 2 631 175 A2 because no outlet is placed at the blade tip. No slot or opening is located at the tip. On the contrary of the present invention, EP 2 631 175 A2 does not use the wingtip vortex core low-pressure area.

U.S. Pat. No. 7,354,247 B2 disclosed a blade for a wind energy turbine system's rotor to influence the aerodynamic boundary layer around the blade in an air stream. The blade has upper and lower opposite faces, opposite leading and trailing edges, means for generating pressurized air which is discharged into the air around the upper or lower faces.

The present invention differs from U.S. Pat. No. 7,354,247 B2 because no means for generating pressurized air discharged into the atmosphere surrounding the blade is present. Contrary to the present invention, U.S. Pat. No. 7,354,247 B2 does not use the wingtip vortex core low-pressure area. JPH 081 331 88A disclosed a resistance reducing device for a wing with an opening at the wing's tip connected through a pipe to pressure adjusting chambers in the wing and suction holes placed in the wing's shell.

The present invention differs from JPH 081 331 88A because the tip is closed. No slot or opening is located at the tip. Furthermore, the pressure is not minimal at the tip but in the vortex core present at a distance from the upper surface near the tip and the trailing edge. Contrary to the present invention, JPH 081 331 88A does not use the wingtip vortex core low-pressure area. CH 209 491A disclosed a rotating cross engine body with an automatic boundary layer system. The boundary layer is removed by centrifugal action through an opening placed at a wingtip. The present invention differs from CH 209 491A because the tip is closed. No slot or opening is located at the tip. Furthermore, the pressure is not minimal at the tip but in the vortex core situated at a distance from the upper surface near the tip and the trailing edge. Contrary to the present invention, CH 209 491A does not use the wingtip vortex core low-pressure area.

### BRIEF DESCRIPTION OF THE SEVERAL VIEWS OF THE DRAWINGS

Having described the invention in general terms, reference will be made to the accompanying drawings, which are not necessarily drawn to scale, and wherein:

FIG. 1 shows a perspective view of a lift-generating body;

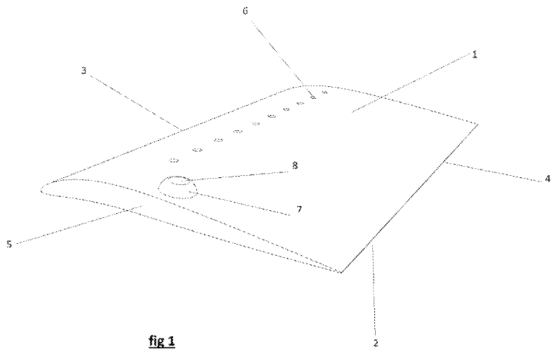

FIG. 2 shows a perspective view of the lift-generating body with the embedded plenum;

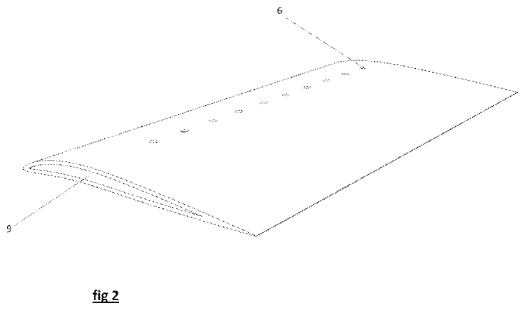

FIG. 3 shows a perspective view of the lift-generating body with multiple plena;

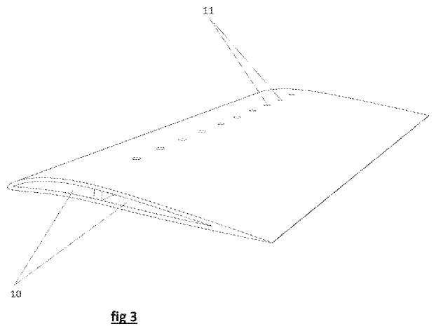

FIG. 4 shows a perspective view of the lift-generating body.

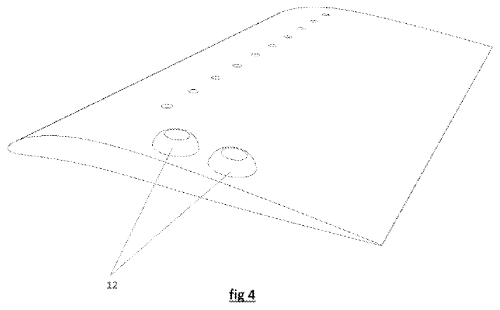

### DETAILED DESCRIPTION OF THE INVENTION

The present invention will be described more exhaustively hereinafter with reference to the accompanying drawings, in which some, but not all the embodiments of the invention are shown. Indeed, the invention may be embodied in many different forms and should not be construed as limited to the embodiments set forth herein; rather, the embodiments are provided so that the disclosure will satisfy applicable legal requirements. Like numbers refer to like elements throughout.

Lift is an aerodynamic force created by the relative motion between a body and a fluid. The body has a leading edge 3 and a trailing edge 4. The imaginary line that directly connects the leading edge 3 to the trailing edge 4 is called the chord. One surface called intrados 2 experiences a higher pressure than another surface on the body called extrados 1. This pressure gradient increases when the body's angle of attack, which is the angle between the direction of motion and the chord, augments until it reaches the critical angle of attack. At the tip of the body 5, a low-pressure area starts to develop within a vortex. That vortex will create an area of low pressure, which is strongest at its center called the core. The core will move onto the upper surface 1 and achieve minimum pressure from the surface 1 and the trailing edge 4 near the tip 5. A pipe or channel 7, protruding from the upper surface 1 near the tip 5 and connected to a plenum 9, extends into the wingtip vortex core. The pipe or channel's outlet 8 present into the wingtip vortex creates a low-pressure area inside the plenum 9 embedded in the lift-generating body. Any hole or slot 6 on the surface and connected to the plenum 9 will be an area of low-pressure. When the pressure in the plenum 9 is lower than the pressure on the extrados 1 at a location where a hole or slot 6 is present, part of the boundary layer on the surface 1 will be sucked into the plenum 9 and expelled at the outlet 8.

When the angle of attack varies in a manner such that there is an inversion of the pressure gradient, meaning that 1 becomes the intrados and 2 the extrados, part of the boundary layer is still sucked into the plenum 9. If there is a sufficient pressure gradient, the design presented herein will still work. However, the boundary layer on an intrados is more stable than the boundary layer on an extrados. Thus, it is more pertinent to apply the suction on the boundary layer located on the extrados for significant gains in lift and substantial reduction of drag. Furthermore, there is a natural corrective effect of the pressure inside the plenum while varying the angle of attack. When the angle of attack increases, the pressure inside the plenum 9 decreases because the vortex core at the outlet 8 gets stronger.

The lift-generating body tip 5 can be rounded or curved to increase the wingtip vortex core's strength.

In specific cases, the pressure inside the plenum 9 may be regulated for optimal performance at different speeds. For such circumstances, a valve system is added to the plenum 9.

The present invention applies to a wing, or rotor blade, or winglets. Many systems like compressor blades, turbines, aircraft wings, wind turbines, or pumps are made of lift-generating bodies. This invention can enhance any device acting on a fluid.

The invention claimed is:

1. An apparatus with a boundary layer suction design by using a core of a wingtip vortex for a lift-generating body, the apparatus comprising:
a lift-generating body with a tip (5) and one surface (2) experiencing a higher pressure than another surface (1);
a leading edge (3) and a trailing edge (4);
a hole or slot (6) placed on one of the surfaces of the lift-generating body;
a plenum (9) embedded in the lift-generating body;
characterize by a pipe or channel (7) protruding from a surface of the lift-generating body near the tip (5) and the trailing edge (4) with an outlet (8) extended into the core of the wingtip vortex.

2. The boundary layer suction design by using a core of a wingtip vortex for a lift-generating body according to claim 1, wherein multiple holes or slots (11) are placed on the surface of the lift-generating body and are all connected to the core of a wingtip vortex via multiple plena (10).

3. The boundary layer suction design by using a core of a wingtip vortex for a lift-generating body according to claim 1, wherein a plenum (9) or multiple plena (10) are connected to a core of a wingtip vortex via multiple pipes or channels (12).
